(19) United States
(12) Patent Application Publication
(10) Pub. No.: US 2025/0169490 A1
(43) Pub. Date: May 29, 2025

(54) TWO PERSON HANGING TREE STAND

(71) Applicant: Steven McCharles, Ottawa (CA)

(72) Inventor: Steven McCharles, Ottawa (CA)

(21) Appl. No.: 19/040,116

(22) Filed: Jan. 29, 2025

Related U.S. Application Data
(63) Continuation of application No. 17/123,174, filed on Dec. 16, 2020.

(51) Int. Cl. A01M 31/02

(52) U.S. Cl. CPC A01M 31/02

(57) ABSTRACT

A two-person hanging tree stand, a novel bracket for hanging said hanging tree stand on a tree, and a novel step assist for assisting transfer from a ladder to a tree stand. A method of manufacturing the novel bracket.

### CROSS-REFERENCE TO RELATED APPLICATIONS

This application is a continuation application of application Ser. No. 17/132,174, filed Dec. 16, 2020 which is a continuation-in-part application from utility application Ser. No. 15/692,446 filed Apr. 25, 2018 which claims priority to provisional patent application Ser. No. 62/491,378, filed Apr. 28, 2017.

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

Tree stands are not new in the prior art. There are a multitude of tree stands on the market today. Each has its own unique features and novelties that distinguish it from all others. The primary features of modern tree stands are safety, practicality, and comfort, and current models that have been patented or on sale are based on such features.

The prior art comprises many hunting stand devices for attachment to trees which provide elevated observation platforms. Such devices fall into three distinctive groups. The first group consists of those stands which are self-climbing stands, the second group consists of stands attached to a tree by a belt called a hang-on stand and the third group consists of stands that have a ladder permanently affixed to the front of the stand which are called ladder stands.

The first, the climbing stand, utilizes a “V” shaped blade, cable or belt on the far side of a tree trunk and a “V” notch in the frame of the platform on the near side, which can be used to climb a tree when used in conjunction with a foot-rest or a seat portion having a similar design. However, this design is limited to trees with no low limbs, as limbs tend to interfere with climbing. This design usually allows for adjustment to compensate for changes in tree diameter with limited level control obtained by adjusting the side braces. The side braces, although adjustable, must be ridged, thereby restricting collapsibility and compactness. Ridged braces and turn buckles also add considerable weight to the structure. All of this lends itself to a heavy load to carry into the woods and back.

The second, strap, belted, chin or cable type hang-on stands, are usually associated with collapsible stands having a seat arrangement, usually pivotal with the base frame. The belt serves to secure the seat support to the tree trunk while the lower frame or standing platform is provided with a “V” slot which pivots toward the tree when weight is applied to the stand. The standing platform is supported by cable braces which allow the vertical seat support to fold flat against the frame in a compact manner.

The third, which are ladder stands, are stands with a seat and platform along with the ladder to climb up into the stand. A ladder stand has a seat and platform that connects to the tree with the ladder attaching to the front of the platform to give the hunter access to the stand. Ladder stands are stationary because of their size and lack the ability to move through the woods quietly. Stability is good because of the connection to the tree and support from the ground. Hunters can use one- and two-person ladder stands.

It is the position of the inventor herein that a true hanging tree stand for two persons is not part of the prior art.

### BRIEF SUMMARY OF THE INVENTION

Thus, what is disclosed and claimed herein is a two-person hanging tree stand. The tree stand comprises a platform, wherein the platform has a rigid structure with a perimeter rail and a plurality of bracing rails attached to the perimeter rail. The platform has a size to accommodate two persons. The perimeter rail is comprised of at least a back rail, wherein the back rail has attached near a center point a hook and receiving bracket for attaching the hanging tree stand to a post or tree.

There are two seats, the seats are located adjacent each other and the seats are supported on the platform back rail by vertical braces. Each seat has a backrest attached to it, and the vertical braces have at least two supporting cross members. One Cross member is located at a seat level and one located at a mid-level of the vertical braces. There is a stand-off plate attached at a back and near a mid-point of the seat level cross member. There is at least one step assist mounted on said perimeter rail.

### BRIEF DESCRIPTION OF THE SEVERAL VIEWS OF THE DRAWING(S)

FIG. 1 is a view in perspective of a two-person hanging tree stand of this invention.

FIG. 2 is a full front view of the upright assembly of the hanging tree stand.

FIG. 3 is full top view of a seat of this invention.

FIG. 4 is a full front view of the seat back assembly.

FIG. 5A is a full top view of the platform assembly.

FIG. 5B is a full side view of the anchoring means for anchoring the platform assembly to the upright assembly.

FIG. 5C is a full top view of one of the means of balancing the platform to a tree.

FIG. 5D is a full side view of the attachment means of FIG. 5C.

FIG. 6 is a view in perspective of the hook component of the attachment assembly.

FIG. 7 is a full back view of the bracket of the attachment assembly.

FIG. 8 is a full top view of the bracket of the attachment assembly.

FIG. 9 is a view in perspective of the bracket of the attachment assembly.

FIG. 10 is a view in perspective of a hanging tree stand showing the novel hook for attaching the stand to a tree.

FIG. 11 is a full view of the novel hook of this invention.

FIG. 12 is a full front view of the support plate of this invention.

FIG. 13 is a side view of the support plate of FIG. 12.

FIG. 14 is a full back view of the support plate of FIG. 12.

FIG. 15 is a view in perspective of the device of this invention showing two step assists and steel mesh covering.

### DETAILED DESCRIPTION OF THE INVENTION

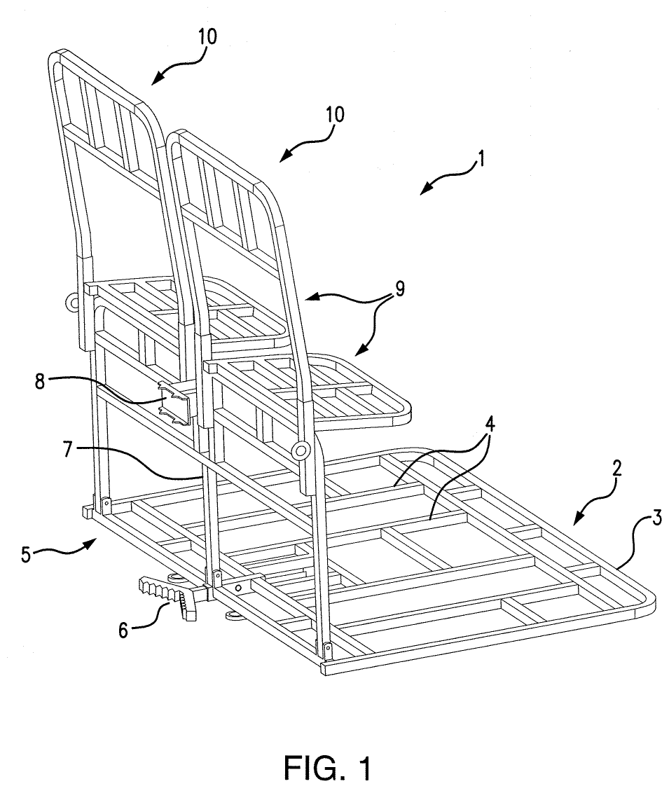

FIG. 1 shows a full view in perspective of a hanging tree stand 1 of this invention. It should be understood that a hanging tree stand does not use support of any kind except an attachment to a tree. Thus, a hanging tree stand does not rely on a ground-to-stand mechanism for support, such as a pole, or a ladder.

There is shown a platform 2, having a perimeter rail 3 and many support rails 4. At the back 5 of the stand 1, there is shown the means 6 by which the stand is maintained level. In this Figure, the means is a spiked “Y” that is forced into the tree by a belt, strap, or chain (not shown). It should be noted that there is a tree mount bracket 8 mounted mid-way up the vertical posts 7 of the seats 9.

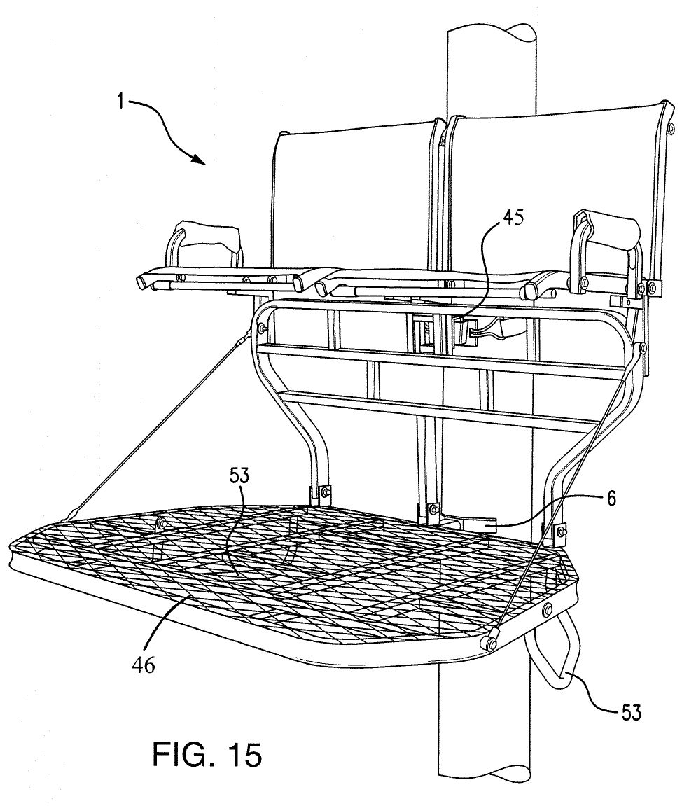

The seats are supported by the posts 7 and they have a back rest 10. It is contemplated within the scope of this invention to cover the platform 2 with expanded metal 46 (see FIG. 15).

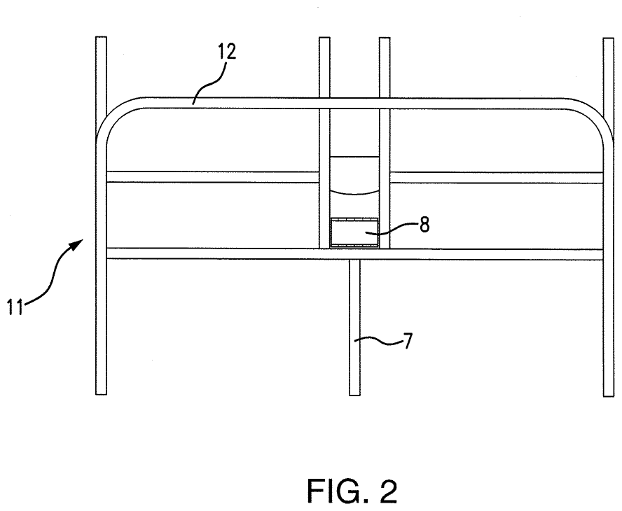

FIG. 2 is a full front view of the upright assembly 11 of the hanging tree stand 1 which also serves as the back rest 10 for the seats 9. It should be noted that this assembly has a periphery rail 12 which is supported by multiple braces. Also shown in this Figure is the tree mount bracket 8.

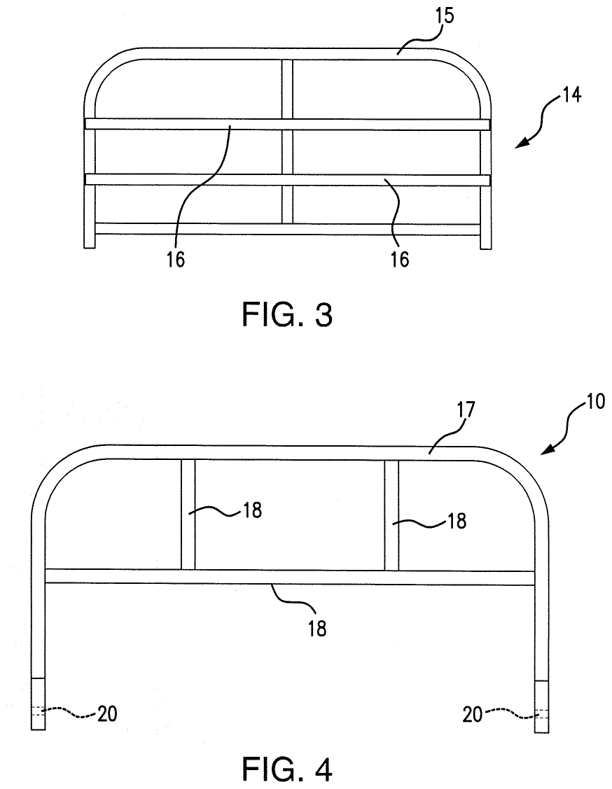

FIG. 3 is full top view of a seat 14 of this invention which is comprised of a periphery rail 15 and support brackets 16.

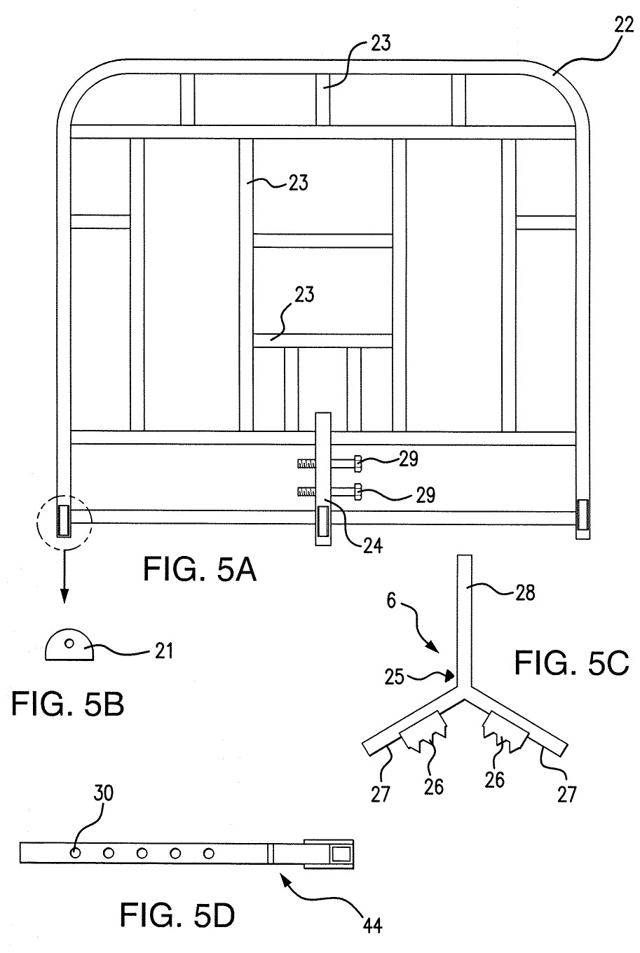

FIG. 4 is a full front view of the seat back rest 10 which also has a periphery rail 17 and support braces 18. It should be noted that the terminal ends 19 of the periphery rail 17 have openings 20 through them (shown in phantom) to accommodate bolts for mounting the seat back rest 10 to the platform 2. This feature, along with the toggles 21 shown in FIG. 5B allow for the foldability of the tree stand into a compact configuration.

FIG. 5A is a full top view of the platform assembly 1 showing the periphery rail 22 and the many support braces 23. Notable is the support 24 for the means 6 for maintaining the device 1 level and balanced. FIG. 5B is a full side view of the anchoring means 21 for anchoring the platform to the upright assembly as discussed Supra.

FIG. 5C is a full top view of one of the means 6 of a standoff for the platform 2. This particular means consists of a “Y” shaped component 25 that has leading spikes 26 on the inside surface 27 (a “V” bar). There is a rod 28 for insertion into the support 24. It should be noted that in this particular configuration there are two bolts 29 for securing the rod 28 in the means 24. FIG. 5D is a full side view of the attachment strap 44 of FIG. 5C showing the openings 30 that can be used to adjust the length of the means 24 in order to make sure that the tree stand 1 is level, balanced and even.

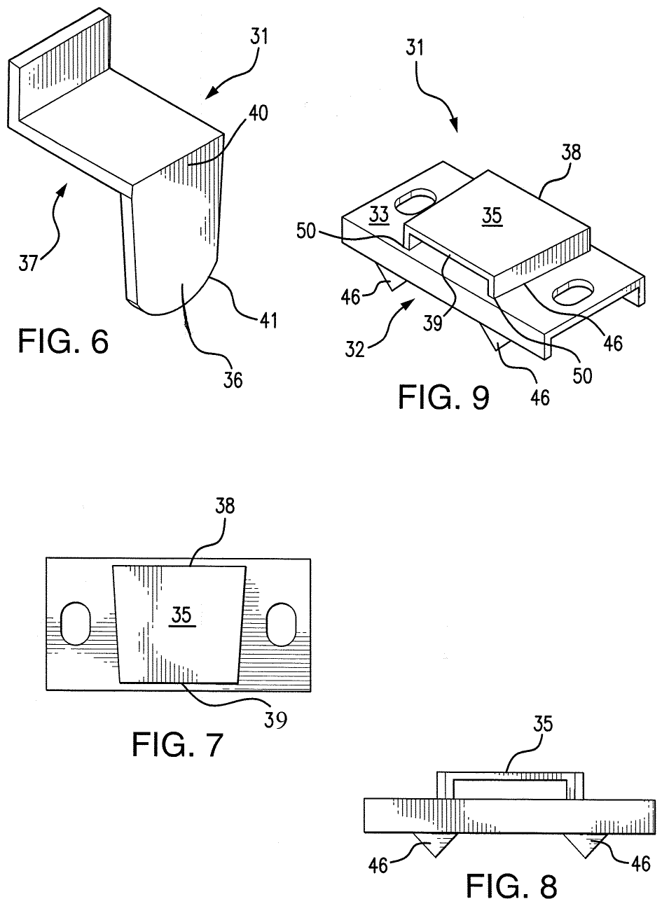

Turning now to FIG. 6 there is shown a view in perspective of a hook component 37 of the novel attachment assembly 45 of this invention (see FIG. 15).

The bracket portion 32 is shown in perspective in FIG. 9 in which a front surface 33 and a back surface 34 (FIG. 12) are shown. Mounted on the back surface 34 are spikes 46 that will insert into a tree. Mounted on the front surface 33 is a receiving device 35 for receiving the spade end 36 of the hook 37 shown in FIG. 6. FIG. 7 is a full back view of the bracket 32 of the attachment assembly and it should be noted that the receiving device 35 is wider at the top 38 than at the bottom 39. It should also be noted that the spade component 36 is wider at the top 40 than at the bottom 41. FIG. 8 is a full top view of the bracket 32 of the attachment assembly.

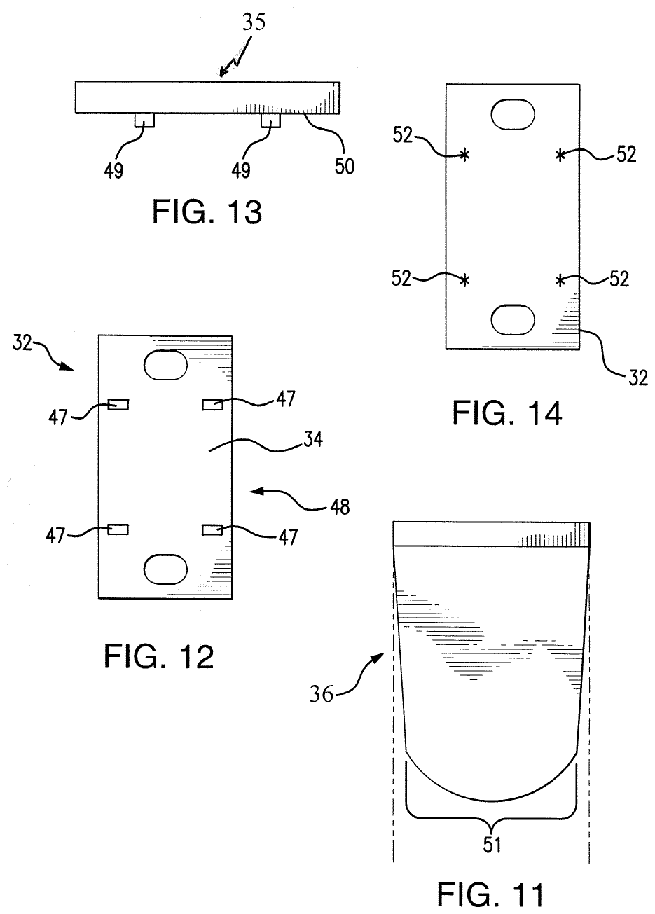

The bracket 35 is intentionally configured such that the top is wider than the bottom. In addition, the spade 35 of the hook 37 is intentionally configured such that the top 40 is wider than the bottom 41. This is configured such that the spade 37 has a clearance of about 14 inch at the top of the bracket 35 to zero clearance at the bottom of the bracket 35. This overall configuration provides a stable fit of the components. It should be noted that the bracket 35 is welded 46 to the front surface 33 of the bracket assembly 32. A full front view of the spade 37 is shown in FIG. 11 to show the narrowing 51 of the spade 37 at the bottom.

This combination of components is unique by the method in which the assembly 32 is manufactured. Turning to FIG. 12, there is shown the back surface 34 of the bracket assembly 32 showing four openings 47 through the support plate 48. In addition, FIG. 13 shows the bracket 35 with two protrusions 49 (only one edge shown) extending from the edges 50 of the bracket 35. Thus, in a method of manufacture, the protrusions 49 of the bracket 35 are inserted into the openings 47 and the protrusions are then welded 52 at the bottom of the support plate 48 as shown in FIG. 14. As noted before, the method includes welding the edges 50 of the bracket 35 to the support plate 48 on the front side of the bracket assembly (designated 46 in FIG. 9).

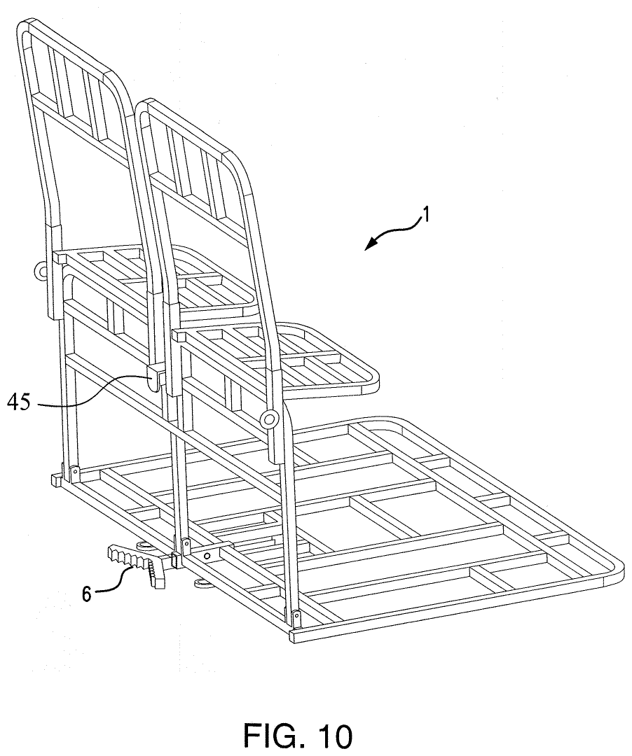

FIG. 10 is a view in perspective of a hanging tree stand showing the novel hook 37 for attaching the stand to a tree.

In use, the bracket 32 is strapped or chained to a tree at the level that the user desires and the spade end 36 of the hook 37 is inserted into the receiving device 35 and seated.

The hanging tree stand 1 is then lifted up to the bracket 32 and the back rail of the hanging tree stand is dropped over the vertical wall 42 which secures the hanging tree stand 1 to the novel attachment assembly 31. The bracket 32 is secured via a chain, strap, or other similar retainer device using the openings 43 in the bracket.

FIG. 15 is a view in perspective of a device of this invention in which the hook and bracket means is used for attachment and there is shown the step assist 53 on both side of the perimeter rail.

The step assist is a new means by which one is assisted from the ladder to the platform of the tree stand in a safe manner.

The tree stands of this invention are manufactured from metal, such as aluminum for lightweightness. The stands are collapsible owing to the manner in which the seats and back, or upright assemblies, are attached to the platform. It is contemplated within the scope of this invention to attach carrying straps to the frame of the stand to enable one to carry the stand. The stands of this invention are readily portable owing to their lightweightness and collapsibility.

What is claimed is:

1. A two-person hanging tree stand, said tree stand comprising:
A. a platform, said platform having a rigid structure with a perimeter rail and a plurality of bracing rails attached to said perimeter rail, said platform having a size to accommodate two persons, said perimeter rail comprised of at least a back rail, said back rail having attached near a center point thereof a hook and receiving bracket for attaching said hanging tree stand to a post or tree;
B. two seats, said seats being located adjacent each other and said seats being supported on said platform back rail by vertical braces, each said seat having a backrest attached to said seat, said vertical braces having at least two supporting cross members, one located at a seat level and one located at a mid-level of the vertical braces, there being a stand-off plate attached at a back and near a mid-point of said seat level cross member;
C. at least one step assist mounted on said perimeter rail.

2. A hanging tree stand as claimed in claim 1 wherein said seats are mounted to said vertical braces such that said seats are foldable against said back rests.

3. A hanging tree stand as claimed in claim 1 wherein said platform is mounted to said back rail such that said platform is foldable against said vertical braces.

4. A hanging tree stand as claimed in claim 1 wherein said platform is covered by an expanded metal covering.

5. A hanging tree stand hanging assembly, said assembly comprising in combination:
A. a hook, said hook having a unitary structure comprised of:
i. a first vertical wall;
ii. a horizontal plate having a first end and a second end, said horizontal plate fixedly attached to a base of said first vertical wall by said first end;
iii. a spade component having a near end and a distal end, said spade component being fixedly attached to said second end of said horizontal plate at said near end of said spade component, said distal end of said spade component being narrower in width than said near end of said spade component;
B. a bracket for accepting said distal end of said spade component, said bracket comprising:
a plate having a front surface and a back surface, said back surface having fixedly mounted thereon, at least two spikes, said plate being U-shaped;
said front surface having mounted thereon, a receptacle for said spade component, there being at least two openings through said plate to accommodate a holding means such as a belt, cable, chain, or a strap.

6. A hanging tree stand hanging assembly as claimed in claim 10 wherein the holding means is a strap.

7. A hanging tree stand hanging assembly as claimed in claim 10 wherein the holding means is a chain.

8. A hanging tree stand handing assembly as claimed in claim 10 wherein the holding means is a belt.

9. In combination a hanging tree stand as claimed in claim 1 and a hanging tree stand hanging assembly, said assembly comprising in combination:
A. a hook, said hook having a unitary structure comprised of:
i. a first vertical wall;
ii. a horizontal plate having a first end and a second end, said horizontal plate fixedly attached to a base of said first vertical wall by said first end;
iii. a spade component having a near end and a distal end, said spade component being fixedly attached to said second end of said horizontal plate at said near end of said spade component, said distal end of said spade component being narrower in width than said near end of said spade component;
B. a bracket for accepting said distal end of said spade component, said bracket comprising a plate having a front surface and a back surface, said back surface having fixedly mounted thereon, at least two spikes, said plate being U-shaped;
said front surface having mounted thereon, a receptacle for said spade component.

10. A method of manufacturing a hanging tree stand hanging assembly, said method comprising:
A. providing a hook, said hook having a unitary structure comprised of:
i. a first vertical wall;
ii. a horizontal plate having a first end and a second end, said horizontal plate fixedly attached to a base of said first vertical wall by said first end;
iii. a spade component having a near end and a distal end, said spade component being fixedly attached to said second end of said horizontal plate at said near end of said spade component;
said distal end of said spade component being narrower in width than said near end of said spade component;
B. providing a first U-shaped plate, said first U-shaped plate have a first end and a second end, there being an opening through said first U-shaped plate near the first end and the second end, there being centrally located, spaced equidistantly apart at least two second openings through said first U-shaped plate, there being a back surface having fixedly mounted thereon, at least two spikes;
C. providing a U-shaped bracket for accepting said distal end of said spade component, said U-shaped bracket comprising a second U-shaped plate having a front surface, a back surface, and two edges defined by the U-shape, said second U-shaped plate having at least two protrusions unitarily attached to the bottom of said edges;
D. aligning and inserting said protrusions into said second openings;
E. welding said protrusions to said first U-shaped plate at said back of said first U-shaped plate and welding said U-shaped bracket to said first U-shaped plate on the said front surface of said first U-shaped plate.
